(19) United States
(12) Patent Application Publication
(10) Pub. No.: US 2008/0014087 A1
(43) Pub. Date: Jan. 17, 2008

(54) Tail rotor for remotely controlled toy helicopter

(75) Inventor: Tom Cheng, Sijhih City (TW)

Correspondence Address: TROXELL LAW OFFICE PLLC;SUITE 1404, 5205 LEESBURG PIKE, FALLS CHURCH, VA, 22041, US

(73) Assignee: ENJOY TOY & HOBBY CORP.

(21) Appl. No.: 11/487,493

(22) Filed: Jul. 17, 2006

(51) Int. Cl. B64C 27/50

(52) U.S. Cl. 416/134 A

(57) ABSTRACT

A tail rotor for a remotely controlled toy helicopter includes a pitch control clevis rotatably mounted on a drive mast and including two side links including a member having an oval tunnel formed at its open end, and a hollow cylinder distal the side links; and a rotor blade assembly including a hub rotatably mounted on an end of the drive mast, two opposite yokes mounted on the hub and each having a pitch link mounted in the oval tunnel and moveably confined therein, and two rotary blades secured to the yoke. The clevis and the rotor blade assembly are adapted to rotate as the drive mast rotates. A linking mechanism is formed by the pitch links and the side links for changing a pitch of the blades and further horizontally changing a direction of a nose of the helicopter while the helicopter is hovering. The invention can increase maneuverability.

### BACKGROUND OF THE INVENTION

1. Field of Invention

The present invention relates to remotely controlled toy helicopters and more particularly to such a remotely controlled toy helicopter having a tail rotor with increased maneuverability.

2. Related Art

A type of remotely controlled toy helicopter is commercially available. The toy helicopter comprises a main rotor for producing forward thrust, and a tail rotor for counteracting the yaw motion and the torque produced by the rapidly turning rotary blades of the main rotor. Further, the tail rotor is adapted to change pitch of its rotary blades for horizontally changing a direction of the helicopter nose while the helicopter is hovering.

A conventional technique of changing pitch of rotary blades of a tail rotor of a toy helicopter is illustrated in FIGS. 1 and 2. In FIG. 1, a pitch control clevis 1″ is slidably mounted on a drive mast and is operatively controlled by a servo motor (not shown). A rotor blade assembly 2″ has its center rotatably fastened at a top end of the drive mast and two pivotal side links pivotably secured to both ends of the clevis 1″.

A first pitch change operation of the tail rotor is illustrated in an upper part of FIG. 2. An inoperative position of the tail rotor is identified by the letter A in which both pitch links (one is shown) 11′ are perpendicular to the base of the clevis 1′. Further, the clevis 1′ may slide down along a drive mast (not shown) in response to a corresponding operation of a servo motor (not shown) as identified by the letter B. At the same time, the pitch links 11′ may flexibly deform toward an axis of rotation through a center of the drive mast due to the inward pulling of both links of the rotor blade assembly 2′. As a result, pitch change of the tail rotor is effected. Furthermore, the clevis 1′ may move up along the drive mast in response to another corresponding operation of the motor as identified by the letter C. At the same time, the pitch links 11′ may flexibly deform away from the axis of rotation due to the outward pulling of both links of the rotor blade assembly 2′.

The above flexible deformations are made possible because the clevis 1′ is formed of an elastomeric material. However, it is known the clevis 1′ may suffer elastic fatigue after a prolonged period of use. Also, such linking mechanism may hinder a smooth operation of the tail rotor and thus decreases a torque output of the motor. To the worse, it may decrease maneuverability of the toy helicopter.

A second pitch change operation of the tail rotor is illustrated in a lower part of FIG. 2. An inoperative position of the tail rotor is identified by the letter A′ in which both pitch links (one is shown) 11″ are perpendicular to the base of the clevis 1″. Further, the clevis 1″ may slide down along the drive mast in response to a corresponding operation of the motor as identified by the letter B′. At the same time, the pivotal pitch links 11″ may pivot toward the axis of rotation due to the inward pulling of both links of the rotor blade assembly 2″. As a result, pitch change of the tail rotor is effected. Furthermore, the clevis 1″ may move up along the drive mast in response to another corresponding operation of the motor as identified by the letter C′. At the same time, the pitch links 11″ may pivot away from the axis of rotation due to the outward pulling of both links of the rotor blade assembly 2″.

The above pivotal link mechanism can eliminate some problems encountered in the first pitch change operation. However, the structure of the pivotal link mechanism is complicated and expensive to manufacture. Thus, the need for improvement still exists.

### SUMMARY OF THE INVENTION

It is therefore an object of the present invention to provide a tail rotor for a remotely controlled toy helicopter having increased maneuverability and being inexpensive to manufacture.

To achieve the above and other objects, the present invention provides a tail rotor mountable on a remotely controlled toy helicopter comprising a drive mast; a pitch control clevis rotatably mounted on the drive mast and including two side links including a ring-shaped member having an oval tunnel formed at its open end, and a hollow cylinder distal the side links; a rotor blade assembly including a hub rotatably mounted on an end of the drive mast, two opposite yokes mounted on the hub and each having a pitch link mounted in the oval tunnel and moveably confined therein, and two rotary blades having one end secured by the yoke; and a sleeve rotatably mounted on the cylinder; wherein the clevis and the rotor blade assembly are adapted to rotate as the drive mast rotates, and wherein a linking mechanism is formed by the pitch links and the side links for changing a pitch of the blades and further horizontally changing a direction of a nose of the helicopter while the helicopter is hovering.

The above and other objects, features and advantages of the present invention will become apparent from the following detailed description taken with the accompanying drawings.

### BRIEF DESCRIPTION OF THE DRAWINGS

FIG. 1 is a perspective view of a conventional tail rotor mounted on a remotely controlled toy helicopter in its inoperative and operative positions respectively;

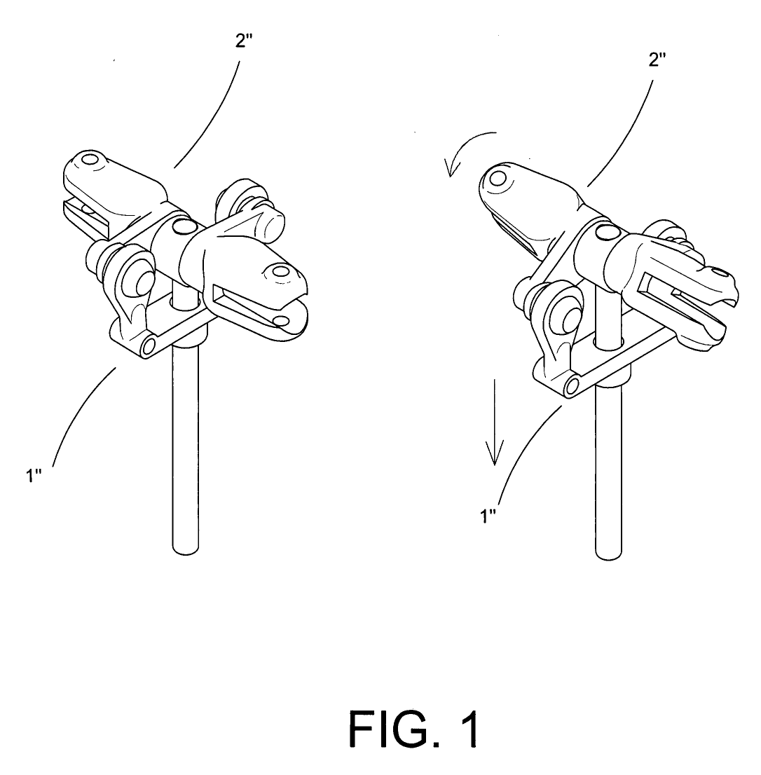

FIG. 2 schematically illustrates first and second pitch change operations of the tail rotor in FIG. 1 in its upper and lower parts respectively;

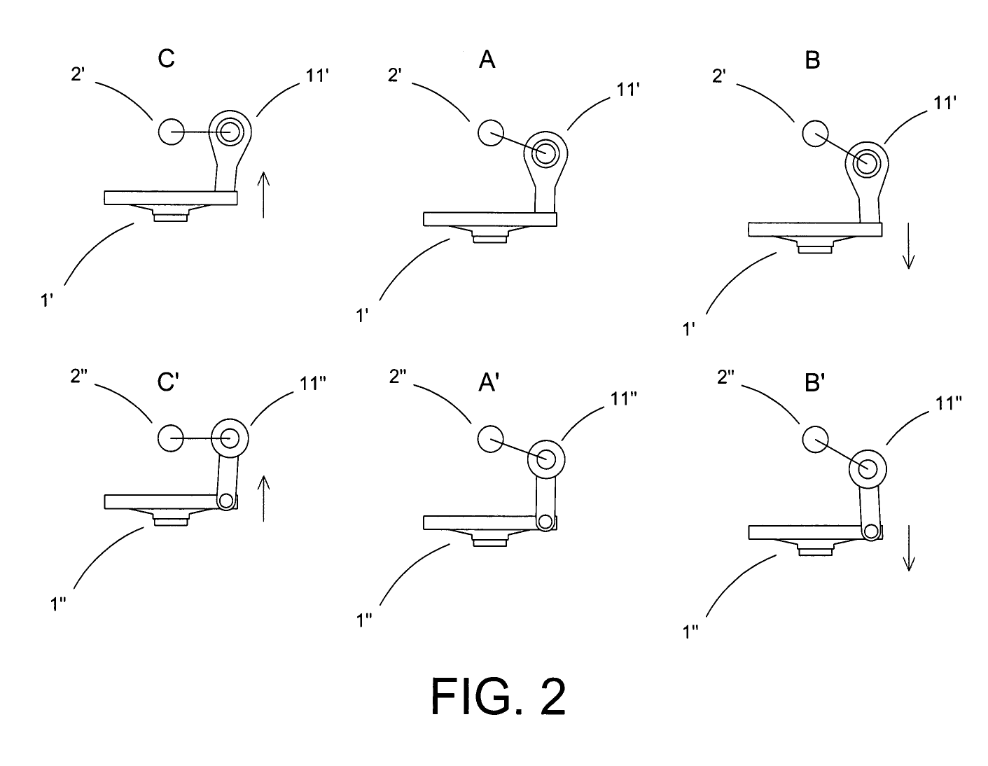

FIG. 3 is an exploded perspective view of a preferred embodiment of tail rotor for a remotely controlled toy helicopter according to the invention;

FIG. 4 is a perspective view of the pitch control clevis in FIG. 3;

FIG. 5 is an exploded view of the tail rotor in FIG. 3; and

FIG. 6 is a perspective view of the assembled tail rotor in FIG. 3.

### DETAILED DESCRIPTION OF THE INVENTION

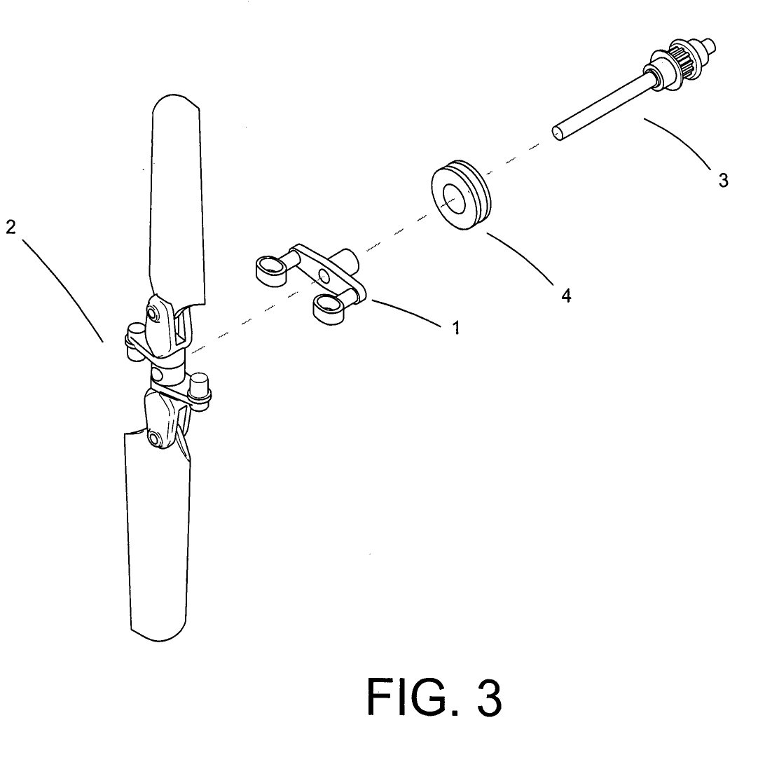

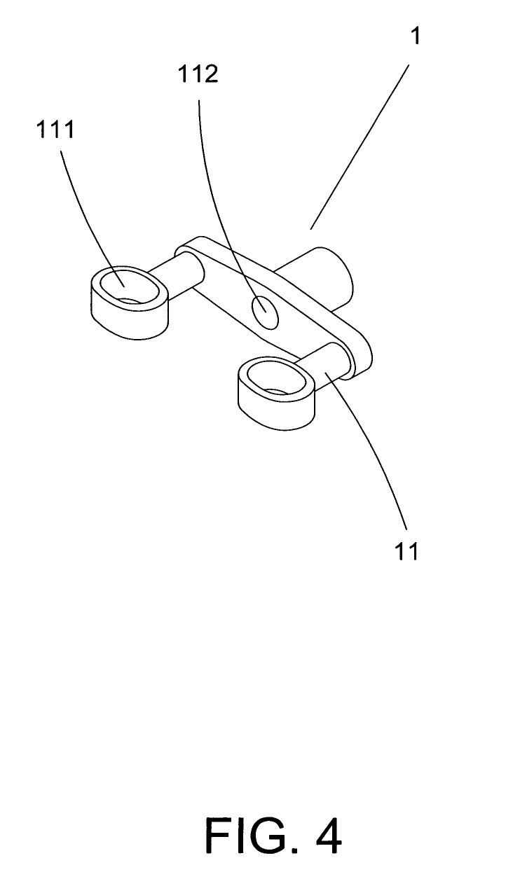

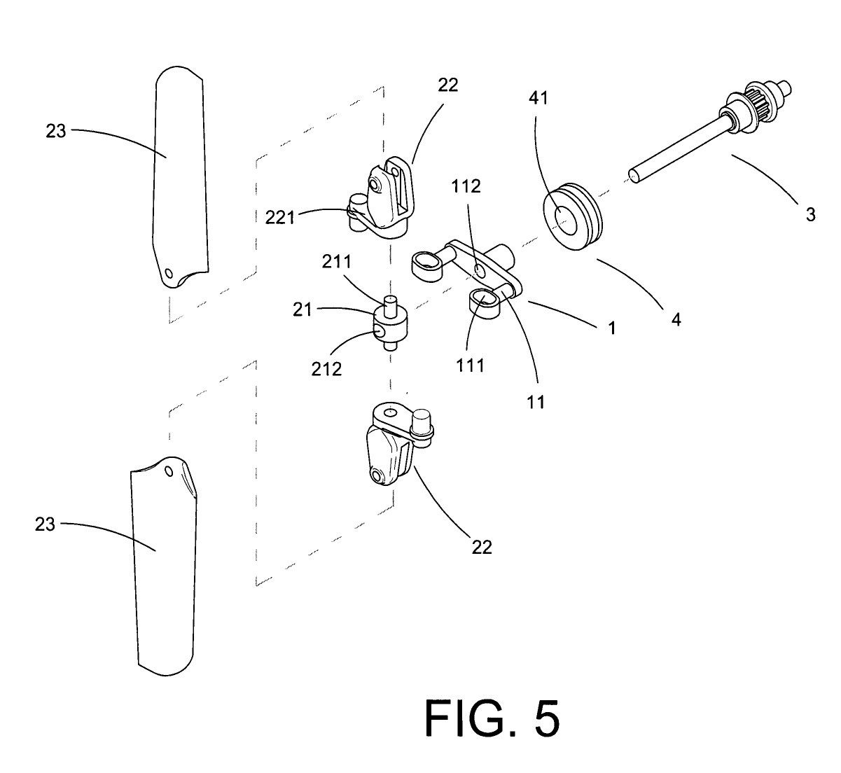

Referring to FIGS. 3 to 6, a tail rotor mounted on a remotely controlled toy helicopter in accordance with a preferred embodiment of the invention comprises a pitch control clevis 1, a rotor blade assembly 2, a drive mast 3, and a sleeve 4. Each component is discussed in detailed below.

The clevis 1 comprises a through hole 112 passing through a center of its base, and two side links 11 extended from both ends of the base, each link 11 having an open end formed as a ring-shaped member having an oval tunnel 111.

The rotor blade assembly 2 comprises a hub 21 including two cylindrical bars 211 projecting from its top and bottom, and a through hole 212 perpendicular to the bars 211; two yokes 22 each mounted on the bar 211 and including a pitch link 221 mounted in the oval tunnel 111 and moveably confined therein; and two rotary blades 23 each having one end secured by the yoke 22.

The sleeve 4 has a through hole 41 put on a cylindrical protrusion projecting from the base of the clevis 1 opposite the links 11. The drive mast 3 is driven by a servo motor (not shown) and is inserted through the through holes 41 and 112 into the through holes 212.

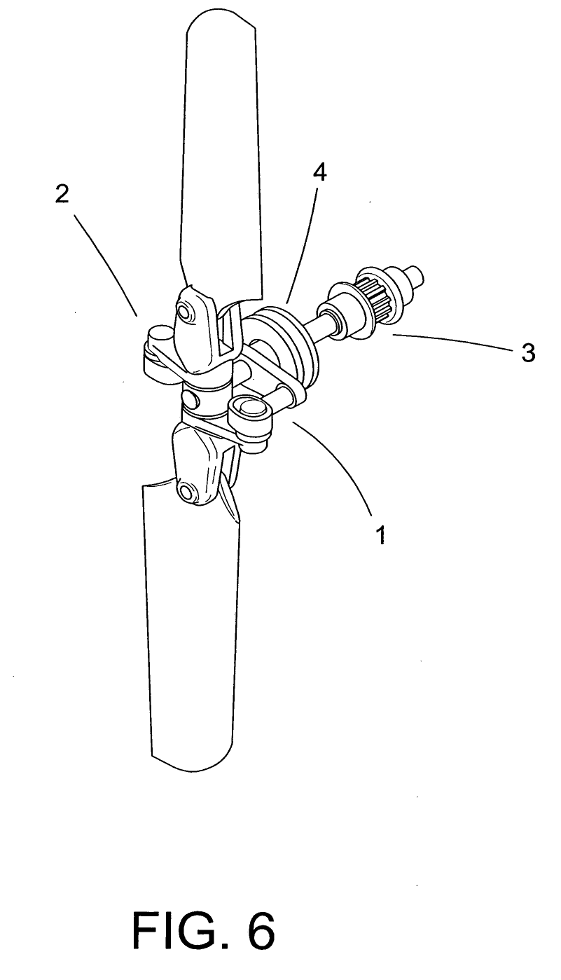

As shown in FIG. 6, both the clevis 1 and the rotor blade assembly 2 rotate as the drive mast 3 rotates. Further, a linking mechanism is formed by the pitch links 221 and the links 11 such that the tail rotor is adapted to change pitch of the blades 23 for horizontally changing a direction of a nose of the helicopter while the helicopter is hovering. Furthermore, the links 11 has some degrees of moving freedom in the oval tunnels 111 for facilitating a pitch change operation of the blades 23.

While the invention herein disclosed has been described by means of specific embodiments, numerous modifications and variations could be made thereto by those skilled in the art without departing from the scope and spirit of the invention set forth in the claims.

What is claimed is:

1. A tail rotor mountable on a remotely controlled toy helicopter comprising:
a drive mast;
a pitch control clevis rotatably mounted on the drive mast and including two side links including a ring-shaped member having an oval tunnel formed at its open end, and a hollow cylinder distal the side links;
a rotor blade assembly including a hub rotatably mounted on an end of the drive mast, two opposite yokes mounted on the hub and each having a pitch link mounted in the oval tunnel and moveably confined therein, and two rotary blades having one end secured by the yoke; and
a sleeve rotatably mounted on the cylinder;
wherein the clevis and the rotor blade assembly are adapted to rotate as the drive mast rotates, and wherein a linking mechanism is formed by the pitch links and the side links for changing a pitch of the blades and further horizontally changing a direction of a nose of the helicopter while the helicopter is hovering.
